(19) United States
(12) Patent Application Publication
(10) Pub. No.: US 2001/0021461 A1
(43) Pub. Date: Sep. 13, 2001

(54) Apparatus for production of fire resistant cellulose insulation from sugar cane bagasse

(76) Inventor: Juan J. Prieto, Hallandale, FL (US)

Correspondence Address: Juan J. Prieto, 1849 S. Ocean Dr. # 309, Hallandale, FL, 33009, US

(21) Appl. No.: 09/840,602

(22) Filed: Apr. 23, 2001

Related U.S. Application Data
(62) Division of application No. 09/456,627, filed on Dec. 7, 1999.
(60) Provisional application No. 60/112,196, filed on Dec. 15, 1998.

(51) Int. Cl. B22F 3/00; B22F 7/00; B22F 7/02; B23K 35/36

(52) U.S. Cl. 428/549

(57) ABSTRACT

An apparatus for production of fire-resistant cellulose material from agricultural byproducts containing cellulose fiber, comprising a first bath for washing said agricultural byproduct cellulose fiber material, a second bath for receiving and mixing said washed agricultural byproduct cellulose fiber material with an effective amount of an aqueous solution suitable for separating said cellulose fibers, conveyer means disposed between said first bath and said second bath for receiving said separated cellulose fibers and moving washed said cellulose fibers to said second bath, and a third bath for receiving and mixing said mixture of separated cellulose fibers produced in said second bath with an effective amount of an aqueous solution suitable for neutralizing said mixture and for producing a fire retardant chemical precipitated on the surface of said cellulose fibers, and conveyer means disposed between said second bath and said third bath for receiving said separated cellulose fibers and moving said separated cellulose fibers to said third bath.

### BACKGROUND OF THE INVENTION

The present invention relates to the insulation materials processed with fire retardant chemicals, which are widely used in the construction industry, specifically, fire-resistant cellulose materials. Building insulation materials are needed to increase thermal performance, while satisfying constraints such as durability, cost, dimensional limits, and environmental, safety, and health concerns. Building insulation materials are used to improve energy savings, fire resistance, sound proofing, and comfort. They are manufactured from mineral fibers, fiberglass, plastic foam, and cellulose materials. Fiberglass insulation is the most widely used residential and commercial buildings in the developed world. Today, this product is coming under scrutiny. Some concerns have been raised regarding the harm from inhaling airborne dispersed fiberglass, which has been found to be potentially carcinogenic.

The second most used insulation product is one that is polyurethane-based. Today, it is well known that human exposure to isocyanate, benzene, and methylene chloride at polyurethane foam manufacturing plants increases the risk of developing cancer; suffering adverse effects on the heart, central nervous system, and liver; irritating the skin, eyes, respiratory system; and acquiring chemical pneumonia.

Several studies have concluded that cellulose insulation produced from recycled paper is the least polluting and most energy efficient and healthy material. Cellulose insulation production consumes about 20-40 times less energy than mineral fiber insulation materials. More importantly, cellulose has a thermal conductivity of approximately 0.026 W/m° K., while standard fiberglass has 0.040 W/m° K. This means that cellulose has a 35-38% larger R-value than fiberglass with same thickness, which translates to better insulation properties.

Several methods exist to produce cellulose pulp, but most are intended for paper, textile, and plastic production because they are more profitable businesses than insulation production. These same methods would be extremely expensive for producing building insulation material. Thus, building cellulose insulation is produced from recycled materials instead of from cellulose pulp. Currently, only 7% of building insulation materials is produced from cellulose. Raw materials used for producing cellulose insulation may range from recycled newspaper, paperboard, and cardboard. These materials are processed to manufacture a finely divided material with a very low-bulk density.

To improve the fire-resistant properties of the cellulose material during production, the raw materials are treated with fire retardant substances that are traditionally applied in powder or liquid solution forms.

Over one hundred patents for producing cellulose insulation from newspapers have been issued since 1949. Some of the fire retardant substances used include ammonium phosphates, ammonium sulfates, carbonates, boric acid, sodium tetraborate and mixtures thereof. For example, cellulose insulation materials and fire retardant substances are discussed in U.S. Pat. Nos. 4,168,175, 4,224,169, 4,342,669, 4,349,413, 4,595,414, 5,455,065, and 5,534,301.

The increment of the cellulose production is well based according to the functionality of this material; however, the increase of the production of the cellulose materials is limited by the availability of the paper residuals since the paper production is the major consumer of this raw material. According to “The Recycler's Handbook,” “a ton of paper made from 100% wastepaper, instead of virgin fiber, saves 17 trees, 7,000 gallons of water and 60 pounds of air-polluting effluents, 4100 kwh of energy, three cubic yards of landfill space and taxpayer dollars, which would otherwise be used for waste-disposal costs.” In contrast, using recycled paper to produce insulation material is neither the most economical nor the best environmental solution.

The present invention gives a solution for producing building cellulose insulation material from agricultural waste and/or agricultural byproducts such as, in a preferred embodiment, sugar cane bagasse, which is the fiber component of the sugar cane stalk remaining after the extraction of sugar cane juice. Byproducts that can be used for the production of fire resistant cellulose material include sugarcane bagasse, guayule bagasse, and other vegetative residuals from the extractive processes of oils, resins, wax, and aromatic components. The apparatus of the invention is based on an innovative process that separates the cellulose fibers from the bagasse material and simultaneously treats them chemically to add the fire-retardant characteristics to produce a low cost and environmentally safe insulation material.

The basis of the present invention is an apparatus for a closed process or method that integrates all major processes for pulp production. This process or method was developed not to produce pulp, but instead, to separate and stabilize the cellulose fibers using chemicals, which later are neutralized to form the fire-retardant and fungi-resistant compounds. These compounds will remain in the cellulose insulation to add fire-retardant characteristics. Thus, this method does not generate waste and gives a high economic effect. This method serves as an option to stop or diminish the utilization of harmful insulation materials. This method serves to reuse a wide group of agricultural byproducts, and agricultural wastes, which alter the ecological equilibrium at the disposal regions. A preferred embodiment of the method uses sugar cane bagasse, which is the fiber component of the sugar cane stalk remaining after the extraction of the sugar cane juice. Byproducts that can be used for the production of fire resistant cellulose material include sugarcane bagasse, guayule bagasse, and other vegetative residuals from the extractive processes of oils, resins, wax, and aromatic components. The present innovation represents an important advance in the state of art of cellulose insulation materials, giving a formulation and benign process for producing thermal insulation.

### BRIEF SUMMARY OF THE INVENTION

The present invention provides an apparatus for producing a low cost insulation from cheapest raw material, by using a minimal amount of process steps and production machinery, conforming a low cost technology-manufacture process. It provides an apparatus for producing a fire resistant cellulose insulation product, which is characterized by a high degree of safety with minimal environmental impact, and which meets all applicable government regulations. The apparatus produces a fire resistant cellulose insulation product that is characterized by a low bulk density, high degree of fiber rigidity, stability, non-toxic, sound proofing, high R value, and fungi resistance.

These benefits are achieved through the exclusive use of the innovative apparatus for simultaneous separation of the cellulose fibers and formation of the insulation material from agricultural by products such as, in one embodiment, sugar cane bagasse which accomplishes the following tasks: mixing the washed bagasse particles with milled paper and cardboard residuals in a primary aqueous solution of chemicals to facilitate the separation and preservation of the cellulose fibers, and neutralizing the mixture in a secondary aqueous solution to produce and precipitate the fire-retardant and fungi-resistant compounds.

The neutralized mixture contains within it the cellulose fibers soaked in fire retardant chemicals. The material can then be compressed and strained to form insulation board panels, insulation compressed cakes or desired end forms of insulation material.

The invention produces a fire resistant cellulose insulation material using a minimal amount of steps using relatively low cost components. This technology does not have byproducts or rejected products and offers a method to separate the cellulose fibers from bagasse and simultaneously treats them chemically to add the fire-retardant characteristics generating none residuals. Moreover, the chemical processes traditionally calculated for the reactors, in the present invention take place on the system of reactor-conveyers giving a high economic effect. The claimed apparatus serves as an example having high ecological significance. The apparatus does not generate residuals and works as an option to stop the incineration of the bagasse, which contaminates the environment. Finally, the present invention represents an advance in the art of cellulose insulation manufacture, and provides many economic, safety, quality control, and other benefits compared with the previous reported technology and cellulose materials, as discussed below.

### BRIEF DESCRIPTION OF SEVERAL VIEWS OF THE DRAWINGS

FIG. 1 is a schematic illustration of the apparatus of the present invention in a preferred embodiment.

### DETAILED DESCRIPTION OF THE INVENTION

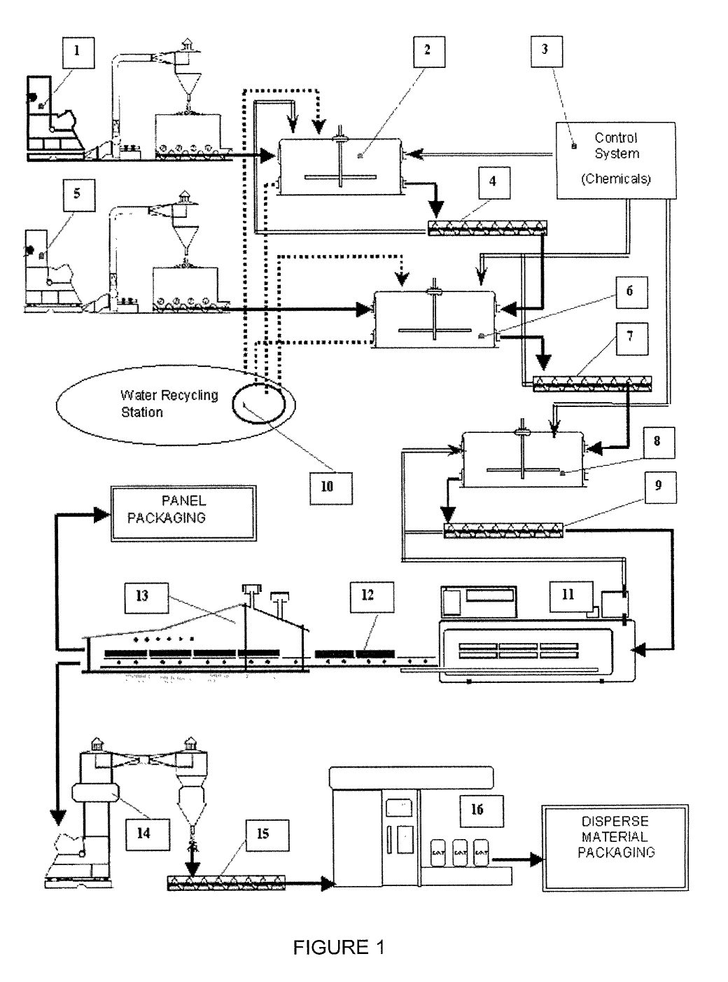

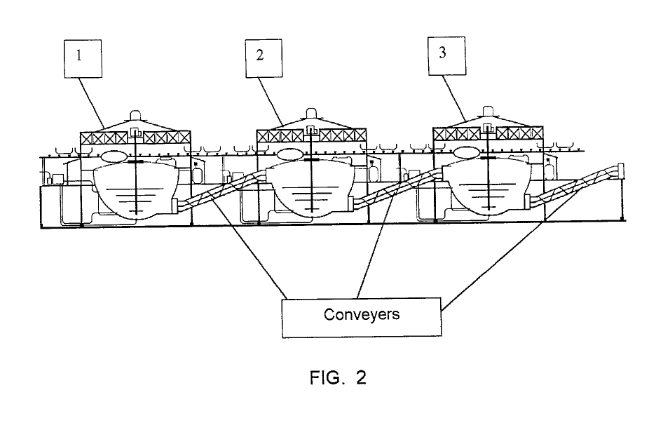

FIG. 1 involves a schematic illustration of the apparatus of the present invention in a preferred embodiment.

Referring now to the numbered elements in FIG. 1, the present invention in a preferred embodiment, comprises the following:

1. Cutter mill, to reduce the bagasse that all of the particles thereof are capable of passing through a sieve within 15 -20 mm of diameter.

2. Bath-I, to wash the reduced material from the remnant sugar and lignin.

3. System to add and control the used chemicals to the operational Baths.

4. Conveyer, special designed as described in FIG. 2.

5. Hammer mill, to reduce the paper and cardboard residuals that all of the particles thereof are capable of passing trough a sieve within 5×5 mm. According to the present invention, other cellulose-containing materials can be incorporated into the residuals, and the type of mill and sieve can be varied depending on needs.

6. Bath-II, to mix the reduced bagasse and paper particles in aqueous solution, and chemically treat the mixture to accelerate the cellulose separation process.

7. Conveyer, analogue to (4).

8. Bath-III, to neutralize the mixture, produces, and precipitates the fire-retardant and fungi-resistant components on the surface of the cellulose material.

9. Conveyer, analogue to (4).

10. Water recycling system.

11. Filter-press, to partially dry the material. Two systems work together in parallel: the first, to perform the insulation panels, and the second, to perform cakes.

12. Conveyer to transport the panels and/or compressed cakes. The panels and cakes are transported on the conveyer into dryer.

13. Dryer. This is a tunnel kiln calculated to work with electric energy and/or solar energy, depending on the weather conditions.

14. Hammer mill, to reduce the dried material to a disperse state for blowing application. For this application in the press-filter were previously prepared the insulation cakes.

15. Conveyor to transport the pulverized material to the desired packaging device.

16. One or more packaging devices.

The baths are specially designed to satisfy the technological exigency of the present invention. The baths are equipped with temperature control, agitation, peristaltic pump and filtration devices. They are connected to the water recycling station, and to the system for chemical control. The dryer is a phenomenal ecological installation calculated to have permanent heat airflow for removing the humidity of the material. For the cloudy days, the solar installation is equipped with air extractor, ventilator and electrical heating to be use optionally.

FIG. 2 is a schematic illustration of the apparatus for producing insulation material comprising a reactor-conveyor system build with baths and conveyers with progressive cavity screw for continuous mechanical, thermo-mechanical and chemical treatment of the cellulose. Referring now to the numbered elements in FIG. 2, the apparatus, in a preferred embodiment, comprises:

1. Bath-I, to wash the reduced material from the remnant sugar and lignin.

2. Bath-II, to mix the reduced bagasse and paper particles in aqueous solution and treat the mixture chemically to facilitate the cellulose fiber separation and conservation.

3. Bath-III, to neutralize the cellulose mixture and precipitate the fire-retardant and fungi-resistant compounds.

The baths are connected between them through the conveyers. The conveyors are enclosed and have an Archimede's screw or progressive cavity screw to transport and separate the cellulose fibers. The baths and conveyers are designed for the thermo mechanical and chemical treatment. The conveyers are built to be able to recycle and reuse the chemical solution, and to facilitate the continuous process during the transportation of the material from one technological step to another. By this procedure the cost of the processes are reduced.

All concentration percentages described below refer to percent by weight of overall mixture. With reference to FIG. 1, the bagasse is milled (1) that all of the particles thereof are capable of passing through a sieve within 15-20 mm of diameter. Later, the material is transported to the Bath-I (2), where the material is washed. In Bath-I, the thermo-mechanical treatment is performed at 50-70 Celsius degrees. The amount of the bagasse particles oscillates between about 20% and about 25% of the water. After strong agitation, the reduced bagasse particles are more dispersed and the lignin and sugars are separated as byproducts. The separated cellulose fibers are carried to Bath-II (6) on a conveyor (4). The conveyor is enclosed and has an Archimede's screw or progressive cavity screw that continue separating the cellulose fibers. The screw continue grinding the fibers and separating the cellulose. The lignin liquor is recuperated and returned back to the Bath-I to continue washing the bagasse. Periodically, the liquor is removed to the water station (10) for recycling or used for vinegar production in parallel station. Chemical treatment will take place in Bath-II to complete the separation of the cellulose fibers. Different chemicals can be used depending of the processing history of the bagasse used for producing insulation material, also depending of the most appropriate fire-retardant component to be produced.

Preferred Chemicals

Table 1 below shows examples of the chemical substances used to facilitate the separation of the cellulose and corresponding group of substances for neutralization that can be used to produce the fire-retardant components.

TABLE 1

| | Chemical | | |
|---|---|---|---|
| | substance | | |
| | for cellulose | Chemical substance | Resulting |
| Example | separation | for neutralization | fire-retardant agent |
| 1 | Sodium | Boric acid | Sodium borate salts |
| | hydroxide | | |
| 2 | Sodium carbonate | Boric acid | Sodium borate salts |
| 3 | Aluminum | Sulfuric acid | Aluminum sulfate |
| | hydroxide | | |
| 4 | Sulfuric acid | Aluminum | Aluminum sulfate |
| | | hydroxide | |
| 5 | Sulfuric acid | Ammonia | Ammonium sulfates |
| | | compound | |
| 6 | Phosphoric acid | Ammonia | Ammonium |
| | | compound | phosphates |

To facilitate the explanation of the preferred embodiments of the present invention, hereto is described the caustic treatment and neutralization with boric acid solution. However the scope of the present invention is not limited to the described example and was developed for the caustic and acid types of cellulose treatment, as well as for the acid and basic neutralization processes.

Following the above declared, in Bath-II the treatment is performed by using sodium hydroxide solution prepared at about 9% to about 15% of normal concentration. Also, the hydroxide solution serves to prevent the possible decomposition of cellulose and hemicellulose of the bagasse. In addition, in Bath-II the bagasse fibers are mixed with the finely divided particles of paper and cardboard. This recycled paper material was previously milled into the hammer mill (5) and it is continuously transported to the Bath-II. The recycled paper and/or cardboard are added in about 10% to about 50% of the bagasse concentration. In Bath-II the chemical substances are impregnated into the cellulose fibers. The total weight of the cellulose mixture should not exceed about 25% of the sodium solution to guarantee an efficient agitation process and sufficient impregnation. To facilitate the mixing process about 5% to about 8% of sodium carbonate is added to the mixture. Thus, chemicals will be added as needed by automated system (3) in order to keep a constant concentration level in Bath-II.

After strong agitation, the mixture of dispersed cellulose materials impregnated in sodium hydroxide and sodium carbonate is carried into Bath-Ill (8) for neutralization. The velocity of the conveyer (7) and its inclination angle is calculated to carry out an equivalent ratio of cellulose mixture and sodium solution (about ½ of the both substances).

In FIG. 2 is shown the reactor-conveyer system. Boric acid solution is added to Bath-III (8) as need for the neutralization process.

The following equations show the chemical reactions of the treatment conducted in Bath-III to neutralize the caustic treated fibers and add fire-retardant compounds:

4H₂O+2 Na(OH)+4H₃BO₃→Na₂B4O₇*10H₂O+H₂O. (1)

In addition, sodium borate production during the neutralization of boric acid with sodium carbonate trough reactions (2), (3), and (4), gives the final reaction (5):

Na₂CO₃+4H₃BO₃→Na₂B₄O₇+H₂CO₃+5H₂O, (2)

H₂CO₃→H₂O+CO₂, (3)

Na₂B₄O₇+10 H₂O→NaB₄O₇*10H₂O, and (4)

Na₂CO₃+4H₃BO₃+4H₂O→Na₂B₄O₇*10H₂O+CO₂. (5)

The neutralization reaction forms the fire-retardant and fungi-resistant compounds making them remain embedded in the insulation material (according previous example: Na2B4O7*10H2O). It is not necessary to wash the fibers, thus, low water is consumed and waste is not generated. Furthermore, due to the slightly slanted slope of conveyors, excess chemicals drip back into the baths to be reuse. The fire retardant compounds are precipitated on the cellulose fiber components as a result of the reaction between the chemicals as they are processed in Bath-II and Bath-III. This results in a high level of dispersion of fire-retardant components with strong affinity to the cellulose fiber structure.

The concentration of the boric acid is calculated to produce a full neutralizing reaction, the pH and concentration of this liquor during the reaction is controlled electronically to have exact amount of the reagents. The boric acid is added in the amount of about 8% to about 15% of the total weigh of the cellulose mixture per times unit of the process. The continuous control of the concentration is very important because from the previous processed cellulose mixture was formed a sodium borate compounds which serves as seed for the continuous formation of the sodium borate salts, including sodium tetra borate. This is a continuous process calculated on the basis of discrete cycles at constant velocity of repetition.

To facilitate the neutralizing reaction, ammonium sulfate is added at about 2% to about 4% of the cellulose material. This salt serves as a catalyst reagent to accelerate the reactions and facilitate the impregnation process of the fire retardant compound to the surface of the cellulose fibers. To facilitate the mixing process about 0.01% to about 0.05% of palm oil is added to the mixture. The produced cellulose material in this technological step is strongly controlled.

Later, the material will be transported (9) into the filter-press system (11). Any chemical compound discharged during press drying process is collected and returned to Bath-III.

A filter-press (11) is used to form a cakes or panels, depending of the type of the used filter-press. The conformed material is transported on the conveyer (12) to the drier (13). This is a ecological tunnel kill calculated to work in any season, geographically situated to receive the most intense radiation to satisfy high energy efficiency. The architectural roof slope is specially designed for the airflow convection from the heat zone to the cold zone, where the water is recuperated by condensation. The solar drier is also provided with electric heater and ventilators for the clouds days. After the drying process the panels are transported to the packaging department. The panels that do not qualify during the quality control are transported to the hammer mill (14), where they are milled together with the insulation cakes prepared specially for the production of the high disperse insulation product. At the end, this fine fibrous material is packaged into bags.

### EXAMPLE

100 Kg of the sugar cane bagasse was milled with the Hammer Mill to 15-20 mm particle diameter and washed at 60-Celsius degree into a Bath-I strongly agitated for approximately 10 minutes. The amount of the bagasse particles oscillates between about 20% and about 25% of the mixture. Later the partially separated cellulose fibers were transported to the Bath-II through the conveyer by dripping the remnant sugar and lignin solution to the Bath-I. The screw of the conveyer continues grinding the fibers and separating the cellulose from the remnant liquor. In Bath-II the cellulose fibers were caustic treated using sodium hydroxide solution prepared at about 9% to about 15% of normal concentration. Subsequently, 40 Kg of the recycled cardboard were added to the Bath-II and mixed with the sugarcane cellulose fibers. The total weight of the cellulose mixture is about 25% of the sodium solution. To facilitate the mixing process about 5% to about 8% of sodium carbonate is added to the mixture. After 10 minutes of strongly agitation, the mixture was transported to the Bath-Ill. From Bath-II to the Bath-III, the velocity of the conveyer and its inclination angle is calculated to carry out an equivalent ratio of cellulose mixture and sodium solution. The measured ratio was approximately 40-60%. The amount of the sodium hydroxide plus sodium carbonate impregnated into the cellulose material was about 7% of the total cellulose weight.

Boric acid solution was added to Bath-II for the neutralization process. The neutralization at 40-50 Celsius degree during 15 minutes required about 100 liter of boric acid solution from about 12% to about 20% of concentration. To facilitate the neutralizing reaction, ammonium sulfate is added at about 2% to about 4% of the cellulose material. This salt serves as a catalyst reagent to accelerate the reactions and facilitate the impregnation process of the fire retardant compound to the surface of the cellulose fibers. To facilitate the mixing process about 0.01% to about 0.05% of palm oil is added to the mixture. The produced cellulose material in this technological step was strongly controlled. The X-ray diffraction analysis of the inorganic composition of the material show a formation of the family borate compounds, including the sodium tetra borate (Na2B4O7*10H2O). The microscopic analysis of the dried cellulose fibers prepared in this example shows that borate salts are strongly fixed and well dispersed on the surface of the fibers, thus the effectiveness of the fire-retardant compound is notably higher than the case of traditionally aspersion of these compounds to the insulation materials.

The processed material in Bath-II was dried into a filter-press to form sample of panels. In addition, the conformed and dried material was pulverized for blowing application. In both cases high quality results, were attained.

By using the named processes, the produced insulation material has a bulk density of 29 Kg/m3. The insulation product experimentally produced in accordance with the invention meets all the applicable government requirements for the fire resistant material, including those stated in ASTM C-739.

The present invention involves numerous advantages attainable to the agricultural byproducts that can be used for the production of fire resistant cellulose material include sugarcane bagasse, guayule bagasse, cellulose-containing farming wastes and byproducts and other vegetative residuals from the extractive processes of oils, resins, wax, and aromatic components.

The present invention may be embodied in other specific forms without departing from its spirit or essential characteristics. The described embodiments are to be considered in all respect only as illustrative and not restrictive and the scope of the invention is, therefore, indicated by the appended claims rather than by the foregoing description. All changes that come within the meaning and range of equivalency of the claims are to be embraced within their scope.

1. An apparatus for production of fire-resistant cellulose material from agricultural byproducts containing cellulose fiber, comprising:
A first bath for washing said agricultural byproduct cellulose fiber material,
a second bath for receiving and mixing said washed agricultural byproduct cellulose fiber material with an effective amount of an aqueous solution suitable for separating said cellulose fibers,
conveyer means disposed between said first bath and said second bath for receiving said separated cellulose fibers and moving washed said cellulose fibers to said second bath,
a third bath for receiving and mixing said mixture of separated cellulose fibers produced in said second bath with an effective amount of an aqueous solution suitable for neutralizing said mixture and for producing a fire retardant chemical precipitated on the surface of said cellulose fibers, and
conveyer means disposed between said second bath and said third bath for receiving said separated cellulose fibers and moving said separated cellulose fibers to said third bath:

2. The apparatus of claim 1, further comprising a cuttermill to cut said agricultural byproduct containing cellulose fiber material into particles having a predetermined diameter prior to washing in said first bath.

3. The apparatus of claim 1, further comprising means for drying the neutralized cellulose fiber material from said third bath.

4. The apparatus of claim 3, further comprising means for collecting and recycling water and excess chemicals extracted from said dried cellulose fiber material for reuse.

5. The apparatus of claim 3, further comprising a hammermill communicating with said drying means for reducing said dried cellulose fiber material into particles of a predetermined size.
